(19) United States
(12) Patent Application Publication
(10) Pub. No.: US 2006/0074678 A1
(43) Pub. Date: Apr. 6, 2006

(54) Prosody generation for text-to-speech synthesis based on micro-prosodic data

(75) Inventors: Steven Pearson, Santa Barbara, CA (US); Joram Meron, Camarillo, CA (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 10/953,878

(22) Filed: Sep. 29, 2004

(51) Int. Cl. G10L 13/06

(52) U.S. Cl. 704/267

(57) ABSTRACT

A prosody modification system for use in text-to-speech includes an input receiving a sequence of prosodic data vectors Pn, measured at time Tn, which samples a sound waveform. A prosody data warping module directly derives new prosodic data vectors Qn from the original data vectors Pn using a function, which is controlled by warping parameters A0, . . . Ak, which avoids round-off errors in deriving quantized values, which has derivatives with respect to A0, . . . Ak, Pn, and Tn that are continuous, and which has sufficiently high complexity to model intentional prosody of the sound waveform, and sufficiently low complexity to avoid modeling micro-prosody of the sound waveform. The smoothness and simplicity of the function ensure that micro-prosodic perturbations and errors in measurement of Tn are transferred directly to the output Qn. The errors are thus reversed during re-synthesis and therefore eliminated, resulting in micro-prosodic perturbations being preserved during re-synthesis.

### FIELD OF THE INVENTION

The present invention generally relates to text-to-speech systems and methods, and relates in particular to prosody generation and prosodic modification.

### BACKGROUND OF THE INVENTION

Many speech synthesis methods rely on concatenation of small pieces of speech (“sound units”) from a recorded speaker. In a text-to-speech synthesizer, for example, the input is text and the output is speech. Especially in the case of whole sentences, the output speech has an intonation (pitch) pattern, a loudness pattern (from emphasis or accent), and also a timing and rhythm, which are collectively referred to as “prosody”. For a speech synthesizer, “prosody generation” (system or method) refers to whatever algorithms were necessary to produce that intonation, loudness, and timing. This is the most difficult part of speech synthesis, and has many steps.

When using concatenation of sound units, one of those steps is (typically) to modify the intonation, loudness, and timing of each sound unit from its original values to target values, which reflect the intonation, loudness, and timing intended by the prosody generation algorithms (system or method). In fact, the “prosodic modification” of the sound units is often thought of as part of “sound generation” or “signal processing”. This is because the target prosody is usually already known by the time the prosodic modification is applied, and thus the prosody was, in some sense, already “generated”. But there are also cases when the output prosody depends, in part, on the nature of the sound units themselves.

In typical speech synthesizer construction, all of the necessary pieces are collected into a “sound unit” database, which becomes a part of the synthesizer. The pieces can be used as-is (sampled PCM data), or can be encoded into a new form, such as source plus filter. In general, however, the pieces still need to be modified from their original pitch, loudness, and timing. This modification is necessary in order to generate speech having a prosody for conveying the meaning of the sentence being synthesized.

Accordingly, there are typically at least four separate parts of speech synthesis: (1) a generation of target prosody (intonation, loudness, and timing, etc.), which is based on the input text (independent of the nature of the sound units); (2) a selection of sound units primarily based on the target phonemic sequence, but also possibly based on similarity with the target prosody, and compatibility with neighboring sound units; (3) a processing of sound units, which may include a modification of the prosody of the sound units in order to match the target prosody; and (4) a concatenation of sound units, which may include a prosodic modification of sound units in order to yield a prosodic continuity between adjacent units and over the entire utterance.

Pitch is often considered to be the more important prosodic feature, and more difficult to handle. Thus in the following description, pitch is the primary focus, even though other prosodic features, including loudness and timing, may be interchangeable in some of the discussion. Most often the pitch is represented as the “period” between periodic pulses in a speech waveform, as opposed to frequency (which is the reciprocal of period), since the period is more useful in the speech synthesis algorithms being considered.

The traditional formula for calculating new pitch periods during prosodic modification causes the new pitch periods to conform to a continuous intonation curve, which is generated by a prosody generation system, based on predefined rules. The goal is to generate a new sequence of periods, Qn, which will have the pitch recommended by this intonation curve.

The intonation curve can be represented as a function F(t), where t is time, and the value is in Hertz (cycles per second). There has to be some starting point (or origin) where the pitch curve is tied to the pulse sequence which is being generated. The first pulse can be supposed as being at time 0.

In a periodic signal, such as this sequence of pulses, the “period” (or time interval) between two adjacent pulses is the reciprocal of the pitch (or intonation in Hertz) at that point. In other words, the period Qn, which is the time between the nth pulse and the (n-1)th pulse, is the reciprocal of the pitch at the time where these pulses will be positioned. Accordingly, Qn=1/F(Tn), where Tn is the time where pulse n will lie. Problematically, it is impossible to know where the nth pulse will lie until Qn has been computed; thus, calculation of Qn according to the above formula is impossible. However, F( ) is expected to be smooth, so the formula Qn=1/F(T[n-1]) can be used instead because it is not clear where to look at F( ) to find the pitch corresponding to a given period.

The algorithm thus proceeds as follows: (0) the zeroeth pulse is at time 0, that is T0=0, and will not need a period since (at the moment) a pulse to the left is not being considered; (1) the period between pulse 0 and pulse 1 can be computed by Q1=1/F(0), such that the time Ti where pulse 1 will lie is Ti=T0+Q1=Q1; (2) the period between pulse 1 and pulse 2 can be computed by Q2=1/F(1), such that the time T2 where pulse 2 will lie is T2=T1+Q2=Q1+Q2; . . . (n) for the nth pulse, Qn=1/F(n-1), and Tn=T[n-1]+Qn=T[n-2]+Q[n-1]+Qn=(by recursion) Q1+Q2+ . . . +Qn=sum(k=1,n){Qk}.

Without “prosodic modification”, one would need copies of each speech sound, for example, with every possible pitch, loudness, and timing. In essence, this is what designers of some “large corpus” synthesis systems attempt to do. These designers seek to minimize any changes in pitch, loudness, and timing that must be applied to the sound units they use. Thus, they collect many examples of each sound unit by the reading and recording of a large text corpus. This large corpus results in a large memory requirement.

The reason these designers seek to minimize pitch changes applied to the original data is that such changes cause distortion in the sound. There are several kinds of distortion that can occur with pitch modification. The exact nature of the distortion depends on the pitch modification method, but there are some commonalties across methods. Potential types of distortion include period jitter distortion, glottal pulse shape distortion, and micro-prosody distortion.

Period Jitter Distortion: Methods that use pitch synchronous overlap-add rely on pitch epoch marking being done before the pitch modification. Errors in pitch epoch marking can introduce unwanted jitter in the synthesized speech (as opposed to natural jitter). In fact, in an experiment with 11 KHz sampled speech, randomly moving epoch marks by plus or minus one sample point caused a very noticeable scratchy sound.

Glottal Pulse Shape Distortion: If speech is considered as produced by a glottal source and vocal tract filter, then experiments show that the glottal pulse shape changes considerably when the pitch changes. This change is more than just a change in period. Thus, most pitch modification methods fail to effectively produce a correct glottal pulse shape when changing to a new pitch. The result is varying degrees of a non-human quality.

Micro-prosody Distortion: Usually, people think of micro-prosody as the small perturbations in pitch near transitional events at the segmental level (for example, plosive release, or lips coming together, etc.). If pitch modification moves the original sound unit toward a target pitch that is rule generated or extracted from data with a different phoneme sequence, then the micro-prosody may be eliminated or distorted from the natural realization. Also, some of what makes a certain person sound unique is contained in similar “micro-pitch” movements. Thus micro-prosody distortion can also cause a loss in the original speaker identity and naturalness.

Distortion can also occur when modifying other prosodic features, such as loudness or timing. For example, subtle changes in the pulse shape can be observed between a soft and loud version of the same vowel, and the simple use of a multiplicitive amplitude factor may not give a satisfactory change in loudness. As another example, the amplitude shape at the onset of voicing is fairly complex, and may lose naturalness or intelligibility if smoothed or forced to match a rule based amplitude curve.

There will always be synthesis applications where the large size of corpus based methods will be unacceptable, and a smaller memory requirement can lead to increased profitability. For reference, not too long ago, computers could only handle speech synthesis systems that had one diphone of each type (typically, 1000 to 2000 such sound units, consisting of two phonemes each). Corpus based systems typically have 100,000 variable size units.

Diphone type synthesizers are useful for their small size; however, they all seem to suffer from the distortions described above. Some diphone synthesis designers record all the units at a monotone, and then limit the output target prosody to also be very monotonic, thus avoiding some distortion. However, the result is still an unappealing and unacceptable voice.

What is needed is a system and method of prosodic modification and generation which allows a synthesizer that takes up a small amount of memory, but at the same time does not introduce unwanted distortion, or loss of speaker identity and naturalness. The present invention fulfills this need.

### SUMMARY OF THE INVENTION

In accordance with the present invention, a prosody modification system for use in text-to-speech includes an input receiving a sequence of prosodic data vectors Pn, measured at time Tn, which samples a sound waveform. A prosody data warping module directly derives new prosodic data vectors Qn from the original data vectors Pn using a function, which is controlled by warping parameters A0, . . . Ak, which avoids round-off errors in deriving quantized values, which has derivatives with respect to A0, . . . Ak, Pn, and Tn that are continuous, and which has sufficiently high complexity to model intentional prosody of the sound waveform, and sufficiently low complexity to avoid modeling micro-prosody of the sound waveform. The smoothness and simplicity of the function ensure that micro-prosodic perturbations and errors in measurement of Tn are transferred directly to the output Qn. The errors are thus reversed during re-synthesis and therefore eliminated, resulting in micro-prosodic perturbations being preserved during re-synthesis.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1A and 1B are two-dimensional graphs comparing an original glottal waveform for speech in FIG. 1A to sound units with modified pitch periods in FIG. 1B;

FIGS. 2A and 2B are two-dimensional graphs demonstrating preservation of micro-prosodic nuances during warping by comparing original sound units for a sentence in FIG. 2A to warped sound units for a sentence in FIG. 2B;

FIGS. 3A and 3B are two-dimensional graphs comparing original sound units in FIG. 3A to warped and cross-faded sound units in FIG. 3B; and

FIG. 4 is a block diagram illustrating a prosody modification system according to the present invention employed by a prosody generation system according to the present invention for use with a text-to-speech system according to the present invention.

### DETAILED DESCRIPTION OF THE PREFERRED EMBODIMENTS

The following description of the preferred embodiment(s) is merely exemplary in nature and is in no way intended to limit the invention, its application, or uses.

The present invention reduces distortion caused by prosodic modification, including the loss of naturalness and speaker identity, without increasing size. The inventive system and method of prosodic modification addresses the above mentioned distortions simultaneously, thus giving a less distorted and more natural sound. The prosody generation system and method can be applied with only the data from a diphone database, and hence need not increase the size of a diphone synthesizer.

The prosody modification method of the present invention takes as input some representation of a sound waveform. It also may take as input, a target pitch function of time, a target loudness function, and a target timing (or time warping) function. The output is an actual waveform, or the information for producing such a waveform. The output waveform is intended to be perceptually identical to the input waveform except that, at various places in time the loudness may have changed, and where periodic, the pitch may have changed, and also expansion and compression in time may have been applied, causing a change in timing. The pitch of the output is typically modified to match the target pitch function, and similarly for loudness, and the output waveform is typically time-warped to match the target timing function. In reality this kind of modification usually causes unwanted distortion, and changes in the signal beyond merely pitch, loudness, and duration. The method of the present invention minimizes this distortion.

Again notice that in the following paragraphs the focus will be on pitch modification. However, there are clear cases where the same discussion could apply to other prosodic features, such as loudness and timing. Qn the other hand, in the context of prosodic modification, pitch differs from other features in that it is inherently measured pitch-synchronously as periods.

The sequence of periods can be extracted during the periodic portions of the input waveform. Often this period information is given as accompanying data to the actual waveforms. For example, during voiced speech, each glottal pulse is considered to have a point, called the “epoch”, where maximum energy is introduced. If all of the epoch points for the input waveform are located in time (called “pitch marking”) prior to prosodic modification, this information can be included with the waveform. This information is given as a sequence of time points, T0, T1, . . . , Tm. During unvoiced (that is, non-periodic) portions, fixed time steps can be used. Thus, implicitly a sequence of periods is provided, P1, P2, . . . , Pm, where Pn=Tn−T[n-1]. A pulse period derivation module derives new pulse periods Qn from the original pulse periods Pn according to:
Qn=F(n,Pn,T0,T1, . . . Tm,A0,A1,A2, . . . Ak)
where F is considered a family of functions determined by the “warping” parameters A0, . . . Ak, and Pn could be given implicitly as an input, since the times Tn are given. Usually, the times, Tn, and periods Pn and Qn are quantized to align with the underlying sample rate employed for the digital representation of sound. For example, if the sample rate is 16 KHz, then the time resolution is 1/16000=0.0625 milli-seconds. Since for periodic signals, the period is the reciprocal of the pitch, this output period sequence, Qn, when applied to the output waveform, in general gives a perceptual change in pitch (also referred to as “warped pitch”).

Prior art has used a formula similar to the above, but which is only dependent on a target pitch function, and not on the epoch times Tn. The prior art function can be expressed analogously to the family of functions of the present invention by the formula:
Qn=F(n,A0,A1,A2, . . . Ak)
where, for example, the A0, . . . Ak can be a representation of the target pitch function. Thus, as it stands, certain prior art is a special case of the formula of the present invention, but is nevertheless distinguishable from the present invention because the new pitch periods Qn are not determined based on the original pitch periods Pn, which are equivalent to the epoch times. An example of such a prior art function is
Qn=F(n,Target_pitch(time))=1.0/Target_pitch(Tn),
where T1=origin time, Tn=T1+sum(i=1,n-1)(Qi), and Target_pitch(time) is given by the prosody module. This is a recursive definition of F. In this case, F does not depend at all on the original periods P1,P2,. . . . But in some cases, designers have incorporated the intonation of the original speech waveform by using a pitch tracking algorithm on the speech waveform, and adding a residual value (in Hertz) to the Target_pitch( ) function. This technique does not have the same positive results as the method of the present invention. This failing of the prior art follows in part from the necessity to represent the periods Qn as integer numbers of sample points at the sampling frequency (like 11.025 KHz of common sound cards). Then, when a pitch tracker is used on the speech waveform, the tracked pitch is next added to a target pitch in Hertz, this pitch curve is then sampled at a derived sequence of time points, 1/pitch is further computed in order to get the period, and finally this period is rounded off to the nearest integer number of sample points, a semi-random error is introduced into the result which causes the final integer valued Qn to be off by plus or minus one sample point.

Thus, the present invention requires certain properties for the function F: (1) F is a smooth function (e.g. a function whose derivatives with respect to Pn are continuous), that is for example, differentiable relative to time, and A0, . . . Ak, and (2) F is such that Qn is “simply” derived from Pn (e.g. pitch periods are directly converted to pitch periods without a frequency conversion), that is to say, F preserves the natural jitter and micro-prosody in the Pn sequence down to the sample rate level of quantization, and (3) F does not depend on a target pitch function, but instead, the warping parameters A0,A1,A2, . . . Ak can be “tuned” or “optimized” so that the output waveform approximates the target pitch function. In the case of approximating a target pitch function, the extent to which the output waveform differs from the target pitch is ideally the inclusion of jitter and micro-prosodic information from the input waveform.

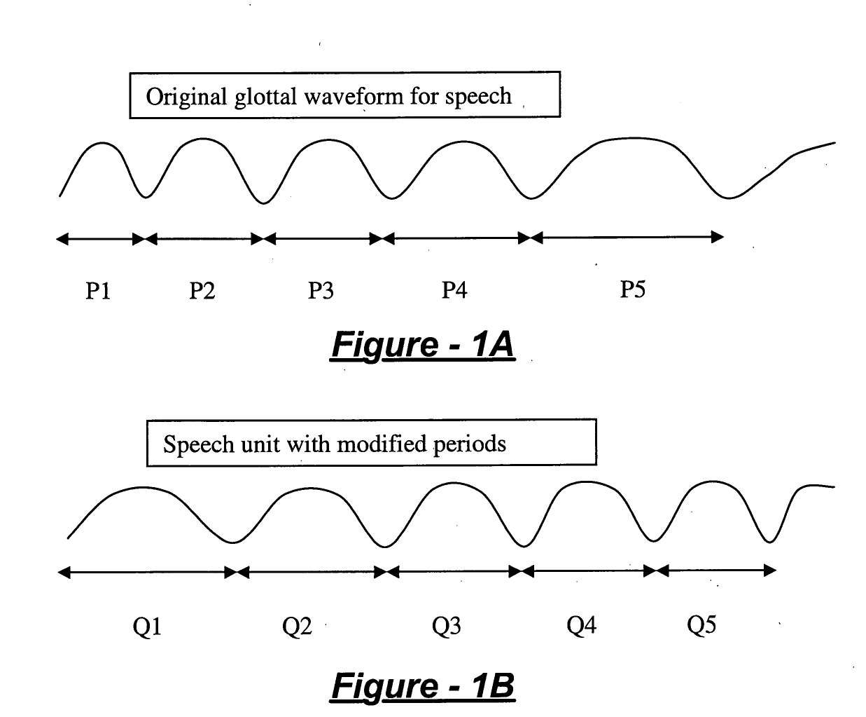

The derivation of a new sequence of periods {Qn} has just been described, however for the purpose of pitch modification, one still needs-a way to apply these periods to the output speech waveform. In some embodiments, the present invention includes a previously disclosed pitch modification algorithm. During synthesis, an overlap-add method is applied to the sequence of glottal pulse waveforms. The known form of this technique basically accomplishes concatenation of glottal pulses, and is more fully described in Pearson, U.S. Pat. No. 5,400,434, which is incorporated by reference herein in its entirety for any puropose. Accordingly, when reconstructing a speech waveform with a new pitch curve, it is appropriate as illustrated in FIGS. 1A and 1B to define a new sequence of pulse periods, Q0, Q1, Q2, . . . , Qn, which replace original pulse periods, PO, P1, P2, . . . , Pn. Then the extracted glottal pulses are re-concatenated with the new periods.

As discussed above, previous prosody modification techniques have generated the new pulse periods according to a target pitch curve supplied by the prosody generation algorithms. The new period is (1/pitch) at points sampled in the supplied pitch curve. Thus, the new periods have been completely unrelated to the original periods.

According to the present invention, however, the new periods are derived from the original periods by a smooth and simple function. Qne example of such a smooth and simple function is
Qn=exp(log(Pn)+A2*Tn*Tn+A1*Tn+A0)
where A0, A1, and A2 are warping parameters to be determined for each diphone and that can be adjusted in order to “warp” the pitch of the input waveform to a desired output pitch function, and Tn is the time from some time origin to the time where the n^{th} pulse will be placed. In this example, the period is modified in the log domain by a simple and smooth 2^{nd} order polynomial of time.

For example, the original pulse sequence may be represented as 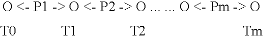
where Tn are the original times of pulses, and Pn the period between pulse n and pulse n-1. Note that here Tn=sum(k=1,n){Pk}=P1+P2+ . . .+Pn.

In the pitch modification method, the goal is to warp the periods Pn into Qn using a 2^{nd} order polynomial function of time. The warped sequence will also have pulse time-points, as in 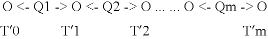
where T′n are the new times of pulses, and T′n=sum(k=1,n){Qk}.

In general, the Qn will not be warped far from Pn, so T′n is similar to Tn. As a result, the formula can use time Tn or time T′n, with slightly different effects. Both can be useful. T′n may be described as the time-points where the warped pulses will be placed, whereas Tn may be described as the time-points where the original pulses were located. It is also possible to approximate the original Tn as if the pulses were evenly spaced (which is approximately true), and then Tn=n, assuming an equal spacing of 1 time unit.

Other examples of a smooth and simple function are
Qn=Pn+A2*Tn*Tn+A1*Tn+A0.
or
Qn=exp(log(Pn)+A2*n*n+A1*n+A0)
As explained above, the formula can be defined recursively. For example, let Tn=sum(i=0,n-1)[Qn], and T0=0. It is envisioned that other smooth and simple functions may be employed as will be readily apparent to those skilled in the art. Thus, while a second order polynomial is presently preferred, it is envisioned that higher (or lower) order polynomials may be employed. The complexity of the function must be sufficiently high to model intentional prosody, and sufficiently low to avoid modeling micro-prosody. This point is discussed in more detail below with respect to the prosody modification system according to the present invention.

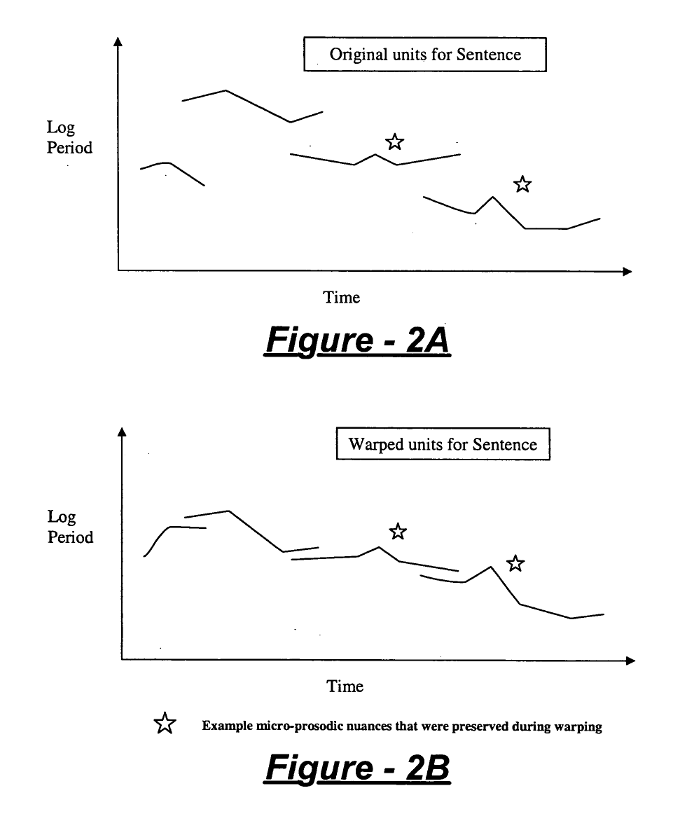

Given any of these example formulas or a similar formula, the pitch curve of the speech waveform can be “warped” into another pitch curve by adjusting the coefficients (A0, A1, A2), but inherent micro-prosodic information is retained as illustrated in FIGS. 2A and 2B. Also, jitter distortion from epoch marking errors is captured, and the re-synthesis “reverses” the error.

In the case of prosodically modifying a sequence of sound units for concatenation synthesis, the method described above is applied to each unit separately. In this case, a time origin can be specified independently for each sound unit. For example, in some embodiments, the segment boundary of each diphone is used as the origin for computing time for that diphone.

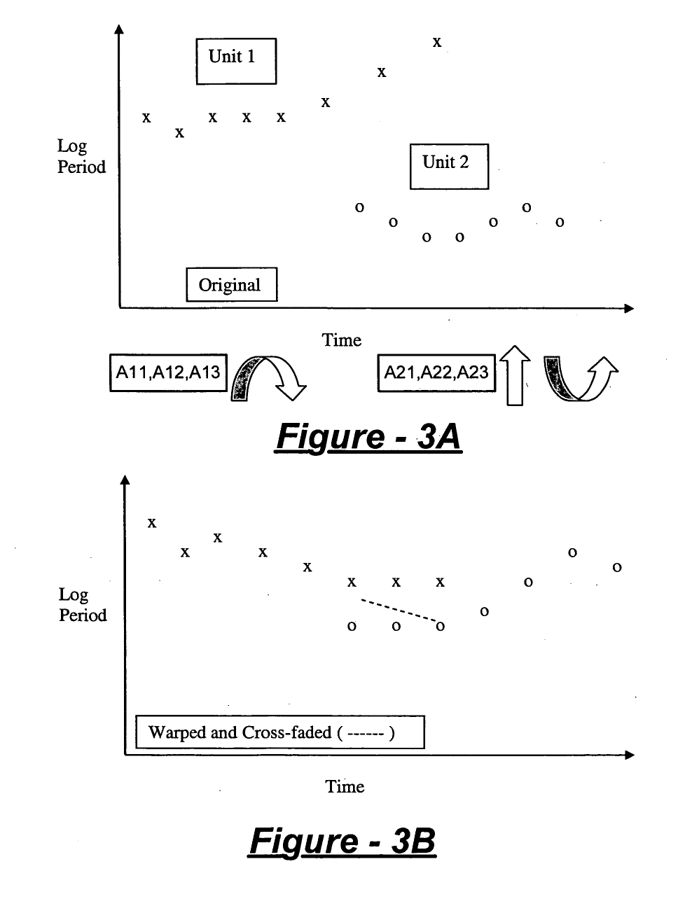

Overlapping two sound units when concatenating raises a question as to what period to use for pulses in the overlapping region. Some embodiments of the present invention use a cross-fade of periods calculated for the two sound units as illustrated in FIGS. 3A and 3B. This “period cross-fade” is synchronous with the waveform cross-fade between the two units. If the cross-fade factor is F, going from 0 to 1, then the cross-faded period is:
P=(1−F)*P1+F*P2
for corresponding periods P1 and P2 from sound units 1 and 2; or
P=exp((1−F)*log(P1)+F*log(P2))
if the log domain is used. This cross-fade also serves to smooth the pitch between adjacent sound units.

Thus, pitch modification of sound units is achieved, but it is not obvious how to set pitch warping parameters for each sound unit in order to get a desired pitch sound. Some embodiments of the present invention use an iterative method which searches through the space of warping parameters to find an optimal solution. Accordingly, depending on the result wanted, various “cost” functions (as explained in more detail below) are employed which, when minimized, yield the optimal warping parameters. In some cases, the locally optimal values can be solved through linear equations.

Global Optimization: When adjusting the warping parameters (for example, A0, A1, A2) for a sequence of sound units, with the goal of producing the best sounding intonation, several factors must be considered. Just as with traditional sound unit concatenation, there is a target cost and a concatenation cost. Within the context of the current invention, a low “target cost” measures how well the prosodically modified sound unit serves the purpose of (1) matching the target prosody (which was generated by rule or by higher level prosodic unit selection), and (2) remaining undistorted in sound quality. The “concatenation cost” corresponds to discontinuity in pitch and timing between adjacent sound units. In a phrase or sentence, the total cost is a sum of the target costs for each unit, plus the concatenation cost across each pair of units. Then the goal can be reformulated as minimizing the total cost for the phrase or sentence by optimally adjusting warping parameters for all units involved.

The cost function is a sum of components, and each component can be “weighted” by a multiplicative factor in order to obtain a balanced result. The weights can be adjusted empirically by hand, or automatically. There are many possible formulas for the component functions.

For the component of target cost that measures how close the warped unit is to the target pitch, two formulas have been employed, but others are possible. Thus, two example components are (1) the square-root of the average squared (RMS) difference between the unit and target pitch, and also (2) just the difference in average of the unit pitch and the target pitch in the target interval of time.

For the component of the target cost that measures the unit's distortion in sound quality, there are also many possibilities. In some embodiments, an RMS distance of the warped unit from its original pitch is used, assuming that the distortion is proportional to the amount of prosodic modification applied to a unit.

To account for the “concatenation cost” component, a cost function can be employed which measures the difference in pitch during the cross-fade regions of adjacent sound units. Typically, this is an RMS distance. Thus, for example, by choosing A0, A1, A2 for adjacent units in such a way as to minimize this cost function, the result is an improvement in pitch continuity.

Now consider the problem of simultaneously (“globally”) optimizing all of the warping parameters for all units in a phrase or sentence. The simplest approach is a “greedy” algorithm, which moves left to right choosing the best local solution for each unit. This works for the target cost which does not include contextual effects, however this method may be sub-optimal when a concatenation cost is included.

One solution employed by some embodiments of the present invention is achieved by an iterative procedure over the phrase or sentence. Each unit is started at a chosen offset in pitch (i.e., no tilting or non-linear warp). Then, iteratively over the sentence, the warping parameters are adjusted for each unit to yield a global minimum in pitch discontinuity (reminiscent of simulated annealing method). The iteration is terminated when the solution converges adequately.

The simplest choice is to start each unit at its original pitch (i.e., no pitch offset at all). Then, in essence, each unit is moved as little as possible, but just enough to compromise with its neighbors. This movement causes the minimum glottal shape distortion. It may seem that this movement would give random and incorrect pitch; however, the units usually have a vowel with a stress feature of primary, secondary, or none. This stress feature is correlated with the pitch; in other words, the unit selection is actually, to some degree, using pitch as a feature.

In a second solution employed by some embodiments of the present invention, the initial pitch values of the units can be started at rule based prosody targets. In this way, the final pitch of a sequence of units converges near the rule prosody, but maintains micro-prosodic nuances.

In a third solution employed by some embodiments of the present invention, the units are initially positioned according to larger prosody units selected from a prosody corpus (for example, word level or phrase level). This solution is a superposition method, with a hierarchy of prosodic units. The bottom of the hierarchy is the sound unit itself, which brings in micro-prosody and jitter effect. Higher level pieces could also be adjusted to minimize discontinuity.

Finally, this global optimization method can be improved upon by specifying, for each unit, how rapidly (or freely) it can move (or warp) in pitch during the iteration process. Thus, a longer unit, or a unit from an important or stressed word may be discouraged from changing in pitch, while a shorter or unstressed unit from an unimportant function word (e.g. “the”) is allowed to move freely. In this way the overall distortion and unnaturalness is further reduced.

In particular, it is useful to inhibit clause or sentence final syllables from moving during the optimization. This preserves the important “sense of finality”, which is cued in part by pitch in American English.

The method has also been used in languages other than English, where a similar improvement in naturalness and intelligibility was found.

In the previous description, the focus was on pitch modification; however, other prosodic features, such as loudness and timing, can be treated with similar methods simultaneously. Thus, instead of talking about Pn as the period at time Tn, one can consider a prosodic feature vector, for example, Pn=( period, loudness, speech-rate), whose components are measured at time Tn. When the warping function and the cost function are redefined multi-dimensionally according to this vector, then the described methods can be used with multiple prosodic features.

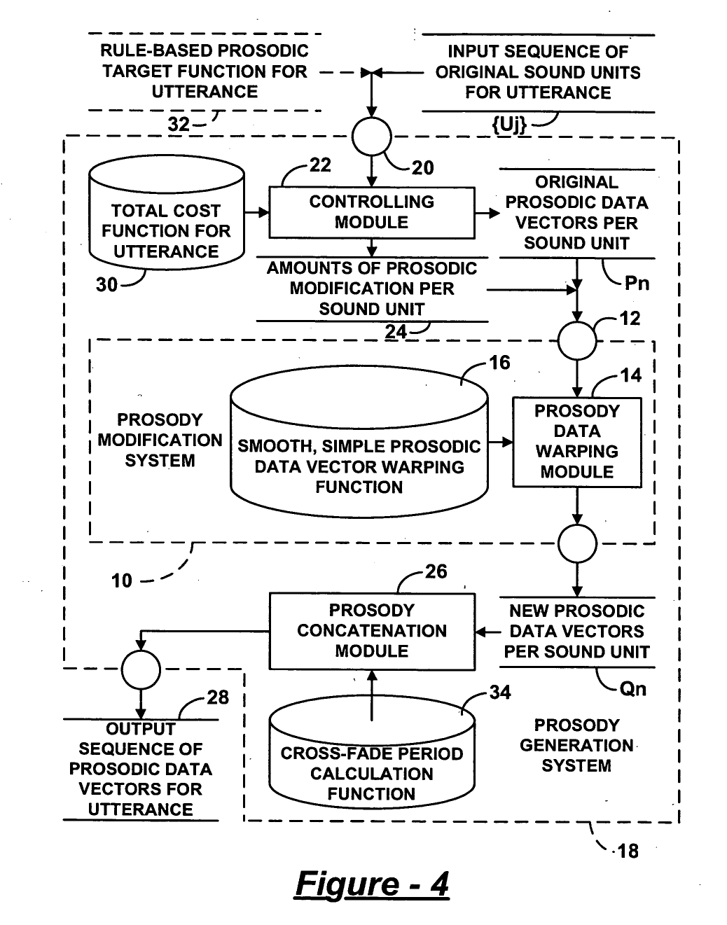

Referring to FIG. 4, the prosody modification system 10 according to the present invention includes an input 12 receiving an original sequence of prosodic data vectors per sound unit Pn, measured at time Tn, which samples a sound waveform. A prosody data warping module 14 directly derives new prosodic data vectors Qn from the original data vectors Pn using a smooth, simple prosodic data vector warping function 16. Function 16 is controlled by warping parameters A0, . . . Ak. Function 16 is smooth in the sense that it avoids round-off errors in deriving quantized values, and has derivatives with respect to A0, . . . Ak, Pn, and Tn that are continuous. It is simple in the sense that it has complexity sufficiently high to model intentional prosody and sufficiently low to avoid modeling the micro-prosody. Function 16 ensures that micro-prosodic perturbations and errors in measurement of Tn are transferred directly to the output Qn, thereby ensuring that the errors are reversed during re-synthesis and therefore eliminated, resulting in micro-prosodic perturbations being preserved during re-synthesis.

Some examples of intentional prosody are habits of speakers in conveying meaning. For example, a speaker may intentionally raise or lower pitch of certain words in order to place emphasis or deemphasize. Also, a speaker may intentionally introduce a pitch gesture to mark a boundary between phrases. Further, a speaker may slowly lower pitch (perhaps unintentionally) when traversing a sentence or other connected sequence of words, and then reset the pitch to a high level when starting a new idea (probably intentionally). These and other behavioral habits of speakers, which are viewed as intentional prosodic pitch motion, are collectively termed herein as intentional prosody.

Some examples of micro-prosody are un-intentional prosodic pitch motion which is usually fairly fine grained and complex. For example, various different voiced phonemes (like M,R,L, A,V) may have slight variations in pitch even though the speaker intended to-give them the same pitch. This variation may be due to the different levels of constriction in the vocal tract that are required to articulate these phonemes. The differing constriction causes differing pressures, which in turn interacts with the glottis. Also, there are small perturbations in pitch near phoneme boundaries, or other articulatory events (such as plosive burst), which are probably caused by interactions between articulators and glottis, but are not fully understood by researchers. Further, there are small fluctuations in the period between glottal epoch points (glottis closure) that is called “jitter”, and is probably caused by the chaotic nature of the turbulence through the glottis. It is desirable to preserve these micro-prosodic gestures during prosodic modification.

Accordingly, function 16 needs to provide a model that separates the micro-prosody from the intentional prosody. Such separation allows the intentional prosody to be controlled from a higher level rule-based module of the text to speech system. This control capability eliminates the need to store sound units for every type of intentional prosody.

While perfect separation of intentional and non-intentional prosody is not feasible, it is possible to choose a simple function to model the intentional prosody locally (in a small space of time). If the function has parameters, these parameters can be adjusted in a curve fitting process to ensure that the function fits the real pitch data as closely as possible. Then, the adjusted function can be subtracted from the real pitch data to yield the microprosody. However, if an overly complex model is employed, then the function will model the microprosody in addition to the intentional prosody. As a result, subtraction of the adjusted function from the real pitch data yields only noise. Thus, the function must be complex enough to model the intentional prosody without modeling the microprosody.

The complexity of the function in part depends on the perspective from which the continuous function is viewed. Any continuous function viewed sufficiently locally may seem linear, but micro-prosodic movement may be excluded at this vantage point. Accordingly the function should be chosen to model the speech data based on the characteristics of the speech waveform. One example of such a function is a polynomial function of time of first to second order. Also, a polynomial function of time of third order may be employed, especially if the coefficient of the cubed component is minimized. Further, zero order polynomials may be useful in some cases. Moreover, trigonometric functions, such as sinusoidal functions, may be ideal. Accordingly, it is not essential to the present invention that the data warping module 14 use a function 16 that incorporates a polynomial of time Tn or incorporates a polynomial in n.

In the case where data warping module 14 uses a function 16 that incorporates a polynomial of time Tn or incorporates a polynomial in n, some embodiments warp a pitch curve of one sound unit (represented as a sequence of pulse periods {Pn}) into another pitch curve (represented by a corresponding sequence of new pulse periods {Qn}) by adjusting coefficients of the polynomial, the coefficients being the pitch warping parameters, while retaining inherent micro-prosodic information.

The prosodic data vectors Qn and Pn can take many forms. For example, the prosodic data vectors Pn can include, as a component, a sequence of periods between adjacent pulses in the sound waveform according to:
Pn=T(n)−T(n-1),
where T(n) is time at an n^{th} pulse, and Qn can be a corresponding new period derived by applying a pitch warping function. Also, the prosodic data vectors Pn can include, as a component, a sequence of amplitudes measured in the sound waveform, where Pn is amplitude at time Tn, and Qn can be a new amplitude for the for the time Tn that is derived by applying an amplitude warping function. Further, the prosodic data vectors Pn can include, as a component, a sequence of speech-rate values measured from the sound waveform, and corresponding output can include new speech rate values derived by applying a speech-rate warping function.

It is envisioned that prosody modification system 10 can be employed as a sub-system of a prosody generation system 18 according to the present invention. System 18 has an input 20 receiving a sequence of original sound units {Uj}, which when concatenated yield a desired synthetic phrase or sentence. A sequence of diphones from a diphone database is one example of such a sequence. Prosody data warping system 10 serves as a module to directly derive new prosodic data vectors {Qjn} from original prosodic data vectors {Pjn} sampled from an original sound unit Uj, and thus modifies perceived prosody of the sound unit. This direct derivation can be achieved in various ways. For example, prosody data warping module 10 can employ segment boundaries of sound units as time origins for computing time Tn for the sound units. Also, prosody data warping module can derive a new period sequence Qjn for each sound unit Uj according to:
Qjn=exp(log(Pjn)+Aj2*Tjn*Tjn+Aj1*Tjn+Aj0),
where Aj0, Aj1, and Aj2 are warping parameters that are determined for sound unit Uj, Pjn is an original period sequence for sound unit Uj, and Tjn is a time at which an n^{th} pulse of Uj is placed respective of a time origin for Uj. Further, prosody data warping module can derives a new period sequence Qjn for each sound unit Uj according to:
Qjn=Pjn+Aj2*Tjn*Tjn+Aj1*Tjn+Aj0
where Aj0, Aj1, and Aj2 are warping parameters that are determined for sound unit Uj, Pjn is the original period sequence for sound unit Uj, and Tjn is a time at which an n^{th} pulse of Uj is placed respective of a time origin for Uj. Yet further, prosodic data warping module can derive Qn according to:
Qn=F(n,T0,T1, . . . Tm,P1,P2, . . . Pm,A0,A1 , . . . Ak)
where F is a family of functions determined by the “warping parameters” A0, . . . Ak. Various alternative functions will be readily apparent to those skilled in the art in view of the present disclosure.

A controlling module 22 determines an amount of prosodic modification 24 for sound units in the input sequence, and presents this information as warping parameters per sound unit, along with prosodic data of the sound units, to the prosody data warping module 10. A prosody concatenation module 26, which concatenates prosodic data of the prosodically modified sound units with adjacent sound units, performs a smoothing of prosodic attributes between adjacent sound units, and outputs a single and final sequence of prosodic data vectors 28, which are synchronized with the entire phrase or sentence.

In some embodiments, controlling module 22 adjusts the warping parameters for each sound unit by minimizing a cost function 30, which is in part, a function of the warping parameters, and whose design is based on desired results pertaining to output speech sound. In some embodiments, controlling module 22 achieves minimization of the cost function 30 by iteratively searching through a space of the warping parameters to find an optimal solution. In some embodiments, controlling module 22 observes different freedom of movement criteria for sound units. These freedom of movement criteria can govern how rapidly sound units can move in prosodic space during iterative search. Motion in searching the warping parameter space can correspond to simultaneous motion of all modified sound units in prosodic space.

Controlling module 22 can observe different freedom of movement criteria in various ways. For example, controlling module 22 can cause relatively longer sound units to move less rapidly in prosodic space than relatively shorter sound units. Also, controlling module 22 can causes a sound unit from a relatively stressed word to move less rapidly in prosodic space than sound units from relatively unstressed words. Further, controlling module can cause a sound unit from a word of relatively more importance in sentence function to move less rapidly in prosodic space than a sound unit from a word of relatively less importance in sentence function. Yet further, controlling module 22 can cause a sound unit from a final syllable of a sentence to move less rapidly in prosodic space than a sound unit from a non-final syllable of the sentence. Further still, controlling module 22 can cause a sound unit from a final syllable of a clause to move less rapidly in prosodic space than a sound unit from a non-final syllable of the clause.

In some embodiments, controlling module 22 can iteratively search through the space of the warping parameters by iteratively searching over a sentence, including starting sound units of the sentence at chosen positions in prosodic space, and adjusting warping parameters of the sound units iteratively over the sentence to yield a global minimum in cost function, and hence a minimum of prosodic discontinuity for the sentence. For example, controlling module 22 can start a sound unit at its original position in prosodic space, thus minimizing overall motion in prosodic space while still yielding a desired level of prosodic continuity for the sentence. Also, controlling module 22 can start each sound unit at rule-based prosody targets of a function 32 provided to input 20 by a text-to-speech system. Further, controlling module 22 can initially position sound units according to larger prosody units selected from a prosody corpus.

Controlling module can operate in various alternative or additional ways. For example, controlling module 22 can achieve minimization of cost function 30 by analytically solving a system of linear equations. Also, controlling module 22 can compute a component part of the cost function by measuring an absolute difference in prosodic data values occurring in cross-fade regions of adjacent sound units, and thus compute prosody warping parameters which improve prosodic continuity between adjacent sound units. Further, controlling module 22 can compute a component part of the cost function by measuring a difference in prosodic data values between an original prosodic value of a sound unit and a warped prosodic value of the sound unit, and thus compute prosody warping parameters which minimize the overall amount of distortion caused by prosodic modification of sound units. Yet further, in the case where input 20 receives a target prosodic function 32 of time, which is derived independently of the sound unit data, controlling module 22 can compute a component part of the cost function by measuring an absolute difference in prosodic data values between an inherent prosodic value of a sound unit and the target prosodic function; thus by minimizing the cost function, controlling module 22 computes prosody warping parameters which yield an output prosody approximating the target prosody function. Even where a cost function 30 is not used, controlling module 22 can still use a target prosodic function 32 of time in its determination of warping parameters for each sound unit. In such a case, controlling module 22 can adjust the warping parameters for each sound unit according to rules, which respond to features derived from input text to a TTS system.

Prosody concatenation module 26 can determine what period to use for pulses in an overlapping region occurring between two overlapping sound units to be concatenated in various ways. For example, prosody concatenation module 26 can calculate a cross-fade of periods for two overlapping sound units that is synchronous with a waveform cross-fade between glottal pulses of the two overlapping sound units using function 34. Also, prosody concatenation module can calculate the cross-faded period P according to:
P=(1−F)*P1+F*P2
for two adjacent sound units respectively having original period P1 and original period P2, wherein a cross-fade factor F is going from 0 to 1. Further, prosody concatenation module 26 can calculate a cross-faded period P according to:
P=exp((1−F)*log(P1)+F*log(P2))
for two adjacent sound units respectively having original period P1 and original period P2 if a log domain pitch representation is desired.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A prosody modification system for use in text-to-speech, comprising:
an input receiving a sequence of prosodic data vectors Pn, measured at time Tn, which samples a sound waveform; and
a prosody data warping module directly deriving new prosodic data vectors Qn from the original data vectors Pn using a function, which is controlled by warping parameters A0, . . . Ak, which avoids round-off errors in deriving quantized values, which has derivatives with respect to A0, . . . Ak, Pn, and Tn that are continuous, and which has sufficiently high complexity to model intentional prosody of the sound waveform, and sufficiently low complexity to avoid modeling micro-prosody of the sound waveform, thereby ensuring that micro-prosodic perturbations and errors in measurement of Tn are transferred directly to the output Qn, causing the errors to be reversed during re-synthesis and therefore eliminated, and resulting in micro-prosodic perturbations being preserved during re-synthesis.

2. The system of claim 1, wherein said data warping module uses a function that incorporates a polynomial of time Tn or incorporates a polynomial in n.

3. The system of claim 2, wherein said data warping module warps a pitch curve of one sound unit (represented as a sequence of pulse periods {Pn}) into another pitch curve (represented by a corresponding sequence of new pulse periods {Qn}) by adjusting coefficients of the polynomial, said coefficients being the pitch warping parameters, while retaining inherent micro-prosodic information.

4. The system of claim 1, wherein said prosodic data vectors include, as a component, a sequence of periods between adjacent pulses in the sound waveform according to:
Pn=T(n)−T(n-1),
where T(n) is time at an n^{th} pulse, and Qn is a corresponding new period derived by applying a pitch warping function.

5. The system of claim 1, wherein said prosodic data vectors include, as a component, a sequence of amplitudes measured in the sound waveform, where Pn is amplitude at time Tn, and Qn is a new amplitude for the for the time Tn that is derived by applying an amplitude warping function.

6. The system of claim 1, wherein said prosodic data vectors include, as a component, a sequence of speech-rate values measured from the sound waveform, and corresponding output includes new speech rate values derived by applying a speech-rate warping function.

7. A prosody generation system for use in text-to-speech synthesis, comprising:
an input receiving a sequence of original sound units {Uj}, which when concatenated yield a desired synthetic phrase or sentence;
a prosody data warping module which directly derives new prosodic data vectors {Qjn} from original prosodic data vectors {Pjn} sampled from an original sound unit Uj, and thus modifies perceived prosody of the sound unit, and
a controlling module, which determines an amount of prosodic modification for sound units in the input sequence, and presents this information as warping parameters per sound unit, along with prosodic data of the sound units, to the prosody data warping module, and
a prosody concatenation module, which concatenates prosodic data of the prosodically modified sound units with adjacent sound units, performs a smoothing of prosodic attributes between adjacent sound units, and outputs a single and final sequence of prosodic data vectors, which are synchronized with the entire phrase or sentence.

8. The system of claim 7, wherein said controlling module adjusts the warping parameters for each sound unit by minimizing a cost function, which is in part, a function of the warping parameters, and whose design is based on desired results pertaining to output speech sound.

9. The system of claim 8, wherein said controlling module achieves minimization of the cost function by iteratively searching through a space of the warping parameters to find an optimal solution.

10. The system of claim 9, wherein said controlling module observes different freedom of movement criteria for sound units, wherein the freedom of movement criteria govern how rapidly sound units can move in prosodic space during iterative search, and wherein motion in searching the warping parameter space corresponds to simultaneous motion of all modified sound units in prosodic space.

11. The system of claim 10, wherein said controlling module causes relatively longer sound units to move less rapidly in prosodic space than relatively shorter sound units.

12. The system of claim 10, wherein said controlling module causes a sound unit from a relatively stressed word to move less rapidly in prosodic space than sound units from relatively unstressed words.

13. The system of claim 10, wherein said controlling module causes a sound unit from a word of relatively more importance in sentence function to move less rapidly in prosodic space than a sound unit from a word of relatively less importance in sentence function.

14. The system of claim 10, wherein said controlling module causes a sound unit from a final syllable of a sentence to move less rapidly in prosodic space than a sound unit from a non-final syllable of the sentence.

15. The system of claim 10, wherein said controlling module causes a sound unit from a final syllable of a clause to move less rapidly in prosodic space than a sound unit from a non-final syllable of the clause.

16. The system of claim 8, wherein said controlling module iteratively searches through the space of the warping parameters by iteratively searching over a sentence, including starting sound units of the sentence at chosen positions in prosodic space, and adjusting warping parameters of the sound units iteratively over the sentence to yield a global minimum in cost function, and hence a minimum of prosodic discontinuity for the sentence.

17. The system of claim 16, wherein said controlling module starts a sound unit at its original position in prosodic space, thus minimizing overall motion in prosodic space while still yielding a desired level of prosodic continuity for the sentence.

18. The system of claim 16, wherein said controlling module starts each sound unit at rule-based prosody target.

19. The system of claim 16, wherein said controlling module initially positions the sound units according to larger prosody units selected from a prosody corpus.

20. The system of claim 8, wherein said controlling module achieves minimization of the cost function by analytically solving a system of linear equations.

21. The system of claim 8, wherein said controlling module computes a component part of the cost function by measuring an absolute difference in prosodic data values occurring in cross-fade regions of adjacent sound units, and thus computes prosody warping parameters which improve prosodic continuity between adjacent sound units.

22. The system of claim 8, wherein said controlling module computes a component part of the cost function by measuring a difference in prosodic data values between an original prosodic value of a sound unit and a warped prosodic values of the sound unit, and thus computes prosody warping parameters which minimize the overall amount of distortion caused by prosodic modification of sound units.

23. The system of claim 8, wherein said input is further receptive of a target prosodic function of time, which is derived independently of the sound unit data, and said controlling module computes a component part of the cost function by measuring an absolute difference in prosodic data values between an inherent prosodic value of a sound unit and the target prosodic function, and thus by minimizing the cost function, computes prosody warping parameters which yield an output prosody approximating the target prosody function.

24. The system of claim 7, wherein said prosody concatenation module determines what period to use for pulses in an overlapping region occurring between two overlapping sound units to be concatenated.

25. The system of claim 24, wherein said prosody concatenation module calculates a cross-fade, of periods for two overlapping sound units that is synchronous with a waveform cross-fade between glottal pulses of the two overlapping sound units.

26. The system of claim 24, wherein said prosody concatenation module calculates a cross-faded period P according to:
P=(1−F)*P1+F*P2
for two adjacent sound units respectively having original period P1 and original period P2, wherein a cross-fade factor F is going from 0 to 1.

27. The system of claim 24, wherein said prosody concatenation module calculates a cross-faded period P according to:
P=exp((1−F)*log(P1)+F*log(P2)
for two adjacent sound units respectively having original period P1 and original period P2 if a log domain pitch representation is desired.

28. The system of claim 7, wherein said input is further receptive of a target prosodic function of time, which is derived independently of the sound unit data, and said controlling module uses the target prosodic function of time in its determination of warping parameters for each sound unit.

29. The system of claim 7, wherein said controlling module adjusts the warping parameters for each sound unit according to rules, which respond to features derived from input text to a TTS system.

30. The system of claim 7, wherein said input receives a sequence of diphones from a diphone database.

31. The system of claim 7, wherein said prosody data warping module employs segment boundaries of sound units as time origins for computing time Tn for the sound units.

32. The system of claim 7, wherein said prosody data warping module derives a new period sequence Qjn for each sound unit Uj according to:
Qjn=exp(log(Pjn)+Aj2*Tjn*Tjn+Aj1*Tjn+Aj0),
where Aj0, Aj1, and Aj2 are warping parameters that are determined for sound unit Uj, Pjn is an original period sequence for sound unit Uj, and Tjn is a time at which an n^{th} pulse of Uj is placed respective of a time origin for Uj.

33. The system of claim 7, wherein said prosody data warping module derives a new period sequence Qjn for each sound unit Uj according to:
Qjn=Pjn+Aj2*Tjn*Tjn+Aj1*Tjn+Aj0
where Aj0, Aj1, and Aj2 are warping parameters that are determined for sound unit Uj, Pjn is the original period sequence for sound unit Uj, and Tjn is a time at which an n^{th} pulse of Uj is placed respective of a time origin for Uj.

34. The system of claim 7, wherein said prosodic data warping module derives Qn according to:
Qn=F(n,T0,T1, . . . Tm,P1,P2, . . . Pm,A0,A1, . . . Ak)
where F is a family of functions determined by the “warping parameters” A0, . . . Ak.

35. A prosody modification method for use in text-to-speech, comprising:
receiving a sequence of prosodic data vectors Pn, measured at time Tn, which samples a sound waveform; and
directly deriving new prosodic data vectors Qn from the original data vectors Pn using a function, which is controlled by warping parameters A0, . . . Ak, which avoids round-off errors in deriving quantized values, which has derivatives with respect to A0, . . . Ak, Pn, and Tn that are continuous, and which has sufficiently high complexity to model intentional prosody of the sound waveform, and sufficiently low complexity to avoid modeling micro-prosody of the sound waveform, thereby ensuring that micro-prosodic perturbations and errors in measurement of Tn are transferred directly to the output Qn, causing the errors to be reversed during re-synthesis and therefore eliminated, and resulting in micro-prosodic perturbations being preserved during re-synthesis.

36. The method of claim 35, wherein directly deriving new prosodic data vectors includes using a function that incorporates a polynomial of time Tn or incorporates a polynomial in n.

37. The method of claim 36, wherein directly deriving new pitch synchronous prosodic data vectors includes warping a pitch curve of one sound unit (represented as a sequence of pulse periods {Pn}) into another pitch curve (represented by a corresponding sequence of new pulse periods {Qn}) by adjusting coefficients of the polynomial, said coefficients being the pitch warping parameters, while retaining inherent micro-prosodic information.

38. The method of claim 35, wherein receiving the sequence includes receiving a sequence of periods between adjacent pulses in the sound waveform according to:
Pn=T(n)−T(n-1),
where T(n) is time at an n^{th} pulse, and Qn is a corresponding new period derived by applying a pitch warping function.

39. The method of claim 35, wherein receiving the sequence includes receiving a sequence of amplitudes measured in the sound waveform, where Pn is amplitude at time Tn, and Qn is a new amplitude for the for the time Tn that is derived by applying an amplitude warping function.

40. The method of claim 35, wherein receiving the sequence includes receiving a sequence of speech-rate values measured from the sound waveform, the method further comprising outputting new speech rate values derived by applying a speech-rate warping function.

41. A prosody generation method for use in text-to-speech synthesis, comprising:
receiving a sequence of original sound units {Uj}, which when concatenated yield a desired synthetic phrase or sentence;
directly deriving new prosodic data vectors {Qjn} from original prosodic data vectors {Pjn} sampled from an original sound unit Uj, thus modifying perceived prosody of the sound unit;
determining an amount of prosodic modification for sound units in the input sequence;
presenting the amount of prosodic modification as warping parameters per sound unit, along with prosodic data of the sound units;
concatenating prosodic data of the prosodically modified sound units with adjacent sound units;
performing a smoothing of prosodic attributes between adjacent sound units; and
outputing a single and final sequence of prosodic data vectors, which are synchronized with the entire phrase or sentence.

42. The method of claim 41, further comprising adjusting the warping parameters for each sound unit by minimizing a cost function, which is in part, a function of the warping parameters, and whose design is based on desired results pertaining to output speech sound.

43. The method of claim 42, further comprising:
receiving a target prosodic function of time, which is derived independently of the sound unit data; and
computing a component part of the cost function by measuring an absolute difference in prosodic data values between an inherent prosodic value of a sound unit and the target prosodic function, and thus by minimizing the cost function, computing prosody warping parameters which yield an output prosody approximating the target prosody function.

44. The method of claim 43, further comprising observing different freedom of movement criteria for sound units, wherein the freedom of movement criteria govern how rapidly sound units can move in prosodic space during iterative search, and wherein motion in searching the warping parameter space corresponds to simultaneous motion of all modified sound units in prosodic space.

45. The method of claim 42, further comprising minimizing the cost function by iteratively searching through a space of the warping parameters to find an optimal solution.

46. The method of claim 42, further comprising minimizing the cost function by analytically solving a system of linear equations.

47. The method of claim 42, further comprising computing a component part of the cost function by measuring an absolute difference in prosodic data values occurring in cross-fade regions of adjacent sound units, and thus computing prosody warping parameters which improve prosodic continuity between adjacent sound units.

48. The method of claim 42, further comprising computing a component part of the cost function by measuring a difference in prosodic data values between an original prosodic value of a sound unit and a warped prosodic value of the sound unit, and thus computing prosody warping parameters which minimize the overall amount of distortion caused by prosodic modification of sound units.

49. The method of claim 41, further comprising:
receiving a target prosodic function of time, which is derived independently of the sound unit data; and
determining the warping parameters for each sound unit based on the target prosodic function of time.

50. The method of claim 41, further comprising adjusting the warping parameters for sound units according to rules, which respond to features derived from input text to a TTS system.
